(19) United States
(12) Patent Application Publication
(10) Pub. No.: US 2025/0010530 A1
(43) Pub. Date: Jan. 9, 2025

(54) INJECTION NOZZLE ATTACHMENT MEMBER, INJECTION DEVICE, AND INJECTION MOLDING MACHINE

(71) Applicant: THE JAPAN STEEL WORKS, LTD., Tokyo (JP)

(72) Inventor: Kiyotaka Nakayama, Tokyo (JP)

(21) Appl. No.: 18/764,749

(22) Filed: Jul. 5, 2024

(30) Foreign Application Priority Data
Jul. 7, 2023 (JP) 2023-112664

(51) Int. Cl. B29C 45/20

(52) U.S. Cl. CPC B29C 45/20

(57) ABSTRACT

An injection nozzle attachment member for attaching an injection nozzle to a tip end of a heating cylinder, the injection nozzle including a body portion and a flange portion, the injection nozzle attachment member including a male thread formed on an outer peripheral surface of a rear end portion and a flange pressing portion configured to press the flange portion against the heating cylinder. The injection nozzle attachment member has a through hole at an axial center for receiving the body portion. The injection nozzle attachment member is configured such that in a case where the through hole receives the body portion inserted and the male thread is screwed into a female thread formed at a tip end of the heating cylinder for attachment to the heating cylinder, the flange pressing portion presses the flange portion for the attachment of the injection nozzle.

### CROSS-REFERENCE TO RELATED APPLICATIONS

This application is based on and claims priority under 35 USC 119 from Japanese Patent Application No. 2023-112664 filed on Jul. 7, 2023, the entire content of which is incorporated herein by reference.

### TECHNICAL FIELD

The present disclosure relates to an injection nozzle attachment member for attaching an injection nozzle to a heating cylinder, an injection device to which an injection nozzle is attached by an injection nozzle attachment member, and an injection molding machine.

### BACKGROUND

An injection device of an injection molding machine includes a heating cylinder and a screw placed in the heating cylinder, and an injection nozzle is provided at a tip end of the heating cylinder. The injection nozzle is attached to the heating cylinder by a predetermined injection nozzle attachment member. For example, a cylinder head as described in JP2020-151745A, that is, a presser, serves as the injection nozzle attachment member. The cylinder head has a through hole in the center, and a body portion of the injection nozzle is inserted into the through hole. The injection nozzle has a flange portion with an enlarged diameter at a rear end portion, and the flange portion is pressed by the cylinder head. A plurality of tapped holes are formed in an end surface of a tip end of the heating cylinder. The cylinder head is fastened to the heating cylinder by a plurality of bolts screwed into the tapped holes, and the injection nozzle is attached to the heating cylinder.

### SUMMARY

In a case where the injection nozzle attachment member is a cylinder head, it is necessary to form a plurality of tapped holes in the end surface of the tip end of the heating cylinder. In order to form a tapped hole, the heating cylinder is required to have a certain thickness, and it may be difficult to drill a hole. It is particularly difficult to drill a tapped hole in small machines where the heating cylinder has a relatively thin wall thickness.

The present disclosure provides an injection nozzle attachment member that enables attachment of an injection nozzle without drilling a tapped hole in an end face of a tip end of a heating cylinder.

Other problems and novel features will become apparent from description of the present description and the accompanying drawings.

An injection nozzle has a cylindrical body portion and a flange portion having an enlarged diameter at a rear end. In the present disclosure, an injection nozzle attachment member for attaching the injection nozzle to a heating cylinder is configured as follows. That is, the injection nozzle attachment member has a through hole at an axial center for receiving the body portion of the injection nozzle inserted, a male thread formed on an outer peripheral surface of a rear end portion, and a flange pressing portion provided at a predetermined portion and configured to press the flange portion of the injection nozzle against the heating cylinder. The injection nozzle attachment member is configured to have the injection nozzle attached by having the body portion inserted into the through hole. Then, the male thread is screwed into a female thread formed at a tip end of the heating cylinder for attachment of the injection nozzle attachment member to the heating cylinder. Thus, the flange pressing portion presses the flange portion for the attachment of the injection nozzle to the heating cylinder.

The injection nozzle attachment member according to the present disclosure enables attachment of an injection nozzle to a heating cylinder without drilling a tapped hole in an end face of a tip end of the heating cylinder.

### BRIEF DESCRIPTION OF DRAWINGS

FIG. 1 is a front view showing an injection molding machine according to the present illustrative embodiment.

FIG. 2 is a front sectional view showing a part of an injection device, an injection nozzle attachment member, and an injection nozzle according to the present illustrative embodiment.

FIG. 3 is a perspective view of the injection nozzle attachment member according to the present illustrative embodiment.

FIG. 4A is a front sectional view showing the injection nozzle attachment member and the injection nozzle according to the present illustrative embodiment.

FIG. 4B is a front sectional view showing the injection nozzle attachment member and the injection nozzle according to the present illustrative embodiment.

FIG. 4C is a front sectional view showing a part of a heating cylinder, the injection nozzle attachment member, and the injection nozzle according to the present illustrative embodiment.

FIG. 4D is a front sectional view showing a part of the heating cylinder, the injection nozzle attachment member, and the injection nozzle according to the present illustrative embodiment.

FIG. 5 is a front sectional view showing a part of an injection device according to a comparative example.

FIG. 6 is a front sectional view showing a part of an injection device according to a modification of the present illustrative embodiment, an injection nozzle attachment member according to the modification, and the injection nozzle.

### DETAILED DESCRIPTION

Hereinafter, specific illustrative embodiments will be described in detail with reference to the drawings. The present disclosure is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

### {Injection Molding Machine}

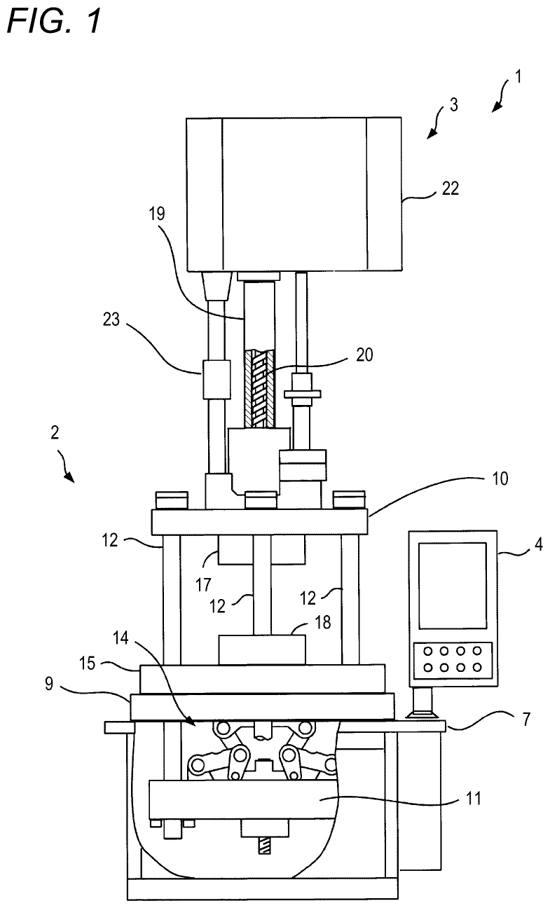

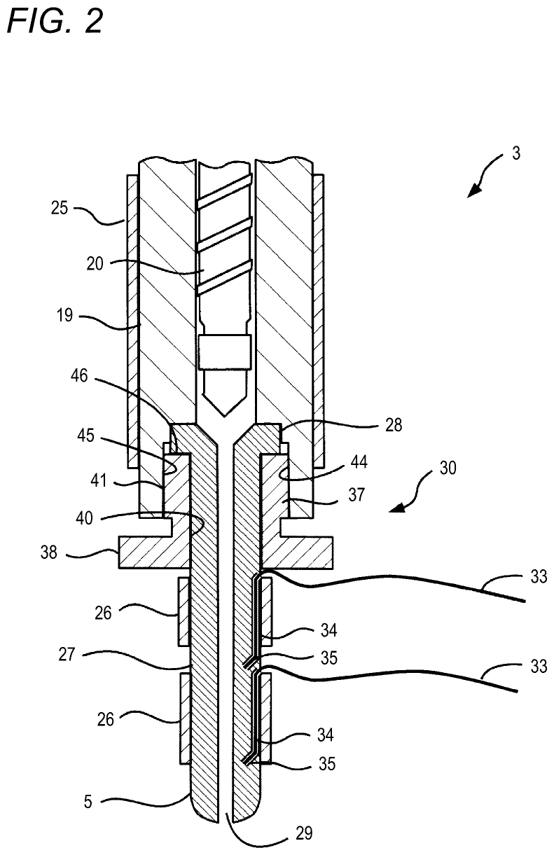

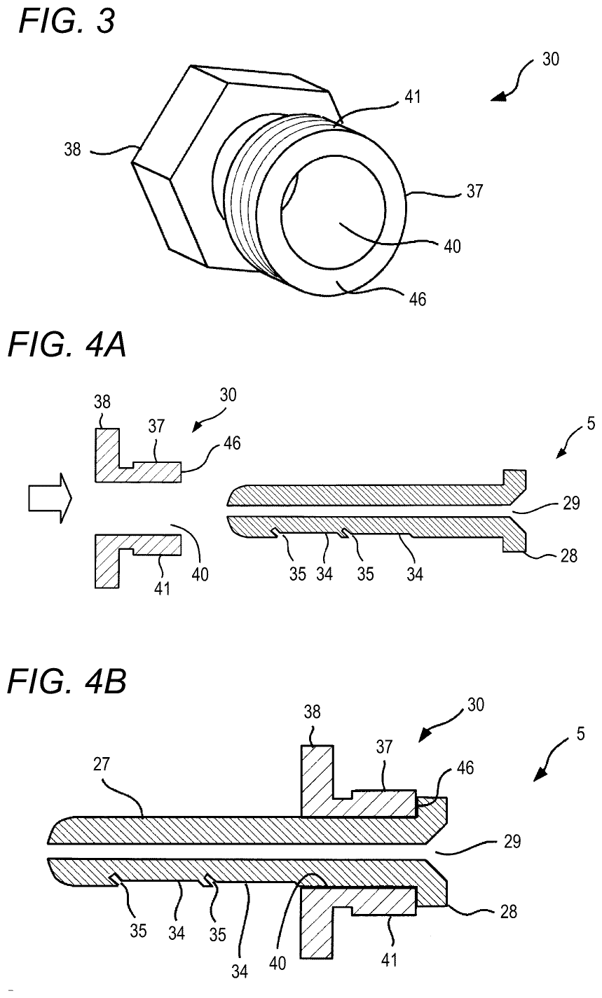

As shown in FIG. 1, an injection molding machine 1 according to the present illustrative embodiment is a so-called vertical injection molding machine. An injection nozzle attachment member 30 according to the present illustrative embodiment, which will be described in detail later with reference to FIGS. 2 and 3, is adapted to attach an injection nozzle 5 in this vertical injection molding machine. However, the injection nozzle 5 may also be attached in a horizontal injection molding machine. That is, the type of the injection molding machine is not limited. The injection molding machine 1 according to the present illustrative embodiment includes a toggle-type mold clamping device 2, an injection device 3, and a control device 4. The control device 4 is configured to control the mold clamping device 2, the injection device 3, and the like.

### {Mold Clamping Device}

The mold clamping device 2 is a so-called vertical mold clamping device. The mold clamping device 2 includes a fixed platen 9 fixed to a bed 7, an upper movable platen 10 provided above the fixed platen 9, and a lower movable platen 11 provided in the bed 7. The upper movable platen 10 and the lower movable platen 11 are coupled by three tie bars 12, 12, . . . . A toggle mechanism 14 is provided between the lower movable platen 11 and the fixed platen 9. A turntable 15 is provided on the fixed platen 9. An upper mold 17 is provided on the upper movable platen 10, and a lower mold 18 is provided on the turntable 15. Driving the toggle mechanism 14 results in opening and closing of the upper mold 17 and the lower mold 18.

### {Injection Device}

The injection device 3 is provided above the upper movable platen 10 of the mold clamping device 2. The injection device 3 includes a heating cylinder 19, a screw 20 provided in the heating cylinder 19, a screw driving device 22, and an elevating device 23 configured to elevate the entire injection device 3. As will be described in detail later, the heating cylinder 19 has an injection nozzle 5 according to the present illustrative embodiment as shown in FIG. 2. The heating cylinder 19 is provided with heaters 25, 25, . . . , and the injection nozzle 5 is provided with nozzle heaters 26, 26, . . . .

### {Injection Nozzle}

As shown in FIG. 2, the injection nozzle 5 includes a relatively long cylindrical body portion 27 and a flange portion 28 having an enlarged diameter. The injection nozzle 5 has a resin flow path 29 formed in an axial center. The flange portion 28 is formed on a rear end side of the injection nozzle 5, that is, on the side to be attached to the heating cylinder 19. As shown in FIG. 2, the injection nozzle 5 is attached to the heating cylinder 19 by the injection nozzle attachment member 30 according to the present illustrative embodiment described below in detail. The injection nozzle 5 is provided with temperature sensors 33 and 33, and nozzle heaters 26 and 26. On an outer peripheral surface of the body portion 27 of the injection nozzle 5, grooves 34 and 34 are formed, and sensor holes 35 and 35 are formed continuously with the grooves 34 and 34, thereby enabling provision of the temperature sensors 33 and 33.

### {Injection Nozzle Attachment Member}

As shown in FIG. 3, the injection nozzle attachment member 30 according to the present illustrative embodiment includes a cylindrical portion 37 and a hexagonal nut-shaped fastening portion 38, and the injection nozzle attachment member 30 has a through hole 40 formed in an axial direction. A male thread 41 is formed on an outer peripheral surface of the cylindrical portion 37. As shown in FIG. 2, a hole 44 in the axial direction is formed in a tip end of the heating cylinder 19, and a female thread 45 is formed on the hole 44. The male thread 41 of the cylindrical portion 37 of the injection nozzle attachment member 30 is adapted to be screwed into the female thread 45. The fastening portion 38 is provided to rotate the injection nozzle attachment member 30 with a tool such as a spanner. In the injection nozzle attachment member 30 according to the present illustrative embodiment, an end surface of a rear end portion of the cylindrical portion 37 forms a flange pressing portion 46 that presses the flange portion 28 of the injection nozzle 5 (see FIG. 2).

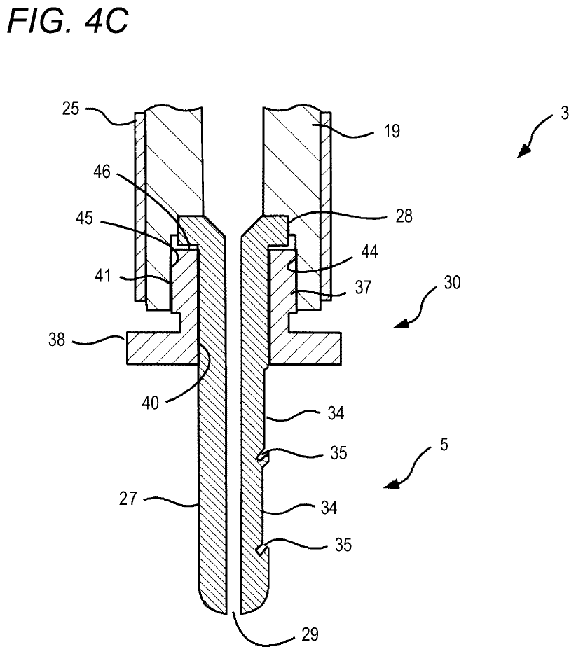

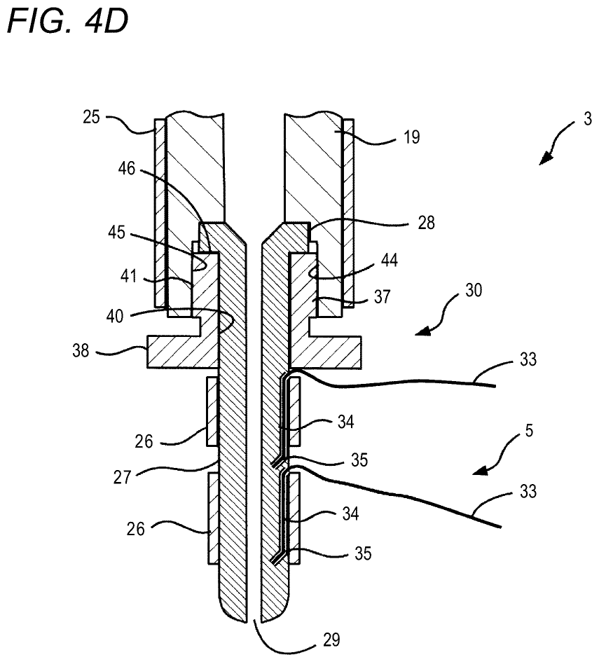

A method of attaching the injection nozzle 5 to the heating cylinder 19 according to the present illustrative embodiment will be described. First, as shown in FIGS. 4A and 4B, the injection nozzle attachment member 30 is mounted on the injection nozzle 5. That is, the body portion 27 of the injection nozzle 5 is inserted into the through hole 40 of the injection nozzle attachment member 30. In a case where the body portion 27 of the injection nozzle 5 is fully inserted into the through hole 40, the end face of the rear end portion of the injection nozzle attachment member 30, that is, the flange pressing portion 46 comes into contact with the flange portion 28 of the injection nozzle 5.

Next, as shown in FIG. 4C, the injection nozzle attachment member 30 according to the present illustrative embodiment, on which the injection nozzle 5 is mounted, is attached to the heating cylinder 19. Specifically, the male thread 41 of the injection nozzle attachment member 30 is screwed into the female thread 45 of the hole 44 in the axial direction of the heating cylinder 19. Then, a tool such as a spanner is engaged with the fastening portion 38, and the injection nozzle attachment member 30 is rotated and fastened. Thus, the flange portion 28 is pressed by the flange pressing portion 46, and the injection nozzle 5 is attached to the heating cylinder 19. As shown in FIG. 4D, the temperature sensors 33 and 33, the nozzle heaters 26 and 26 and the like are attached to the injection nozzle 5 as necessary. The attachment of the injection nozzle 5 to the heating cylinder 19 is now complete.

### Comparative Example

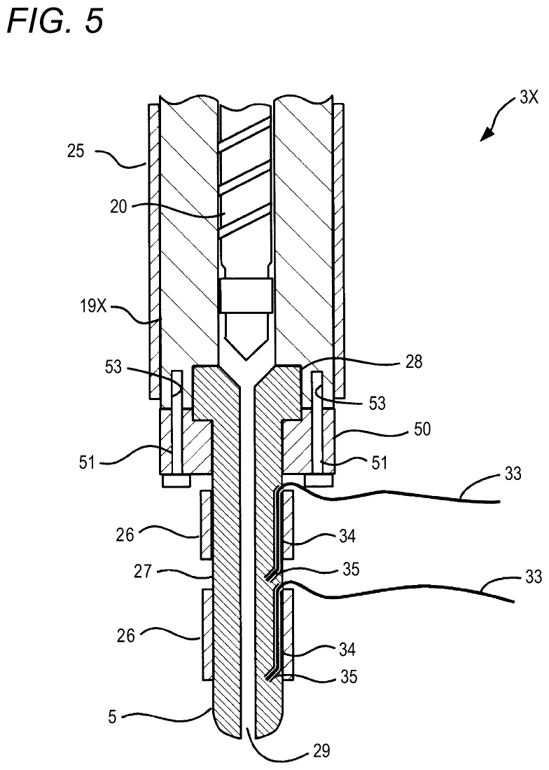

The injection nozzle attachment member 30 according to the present illustrative embodiment is adapted for attachment even for the heating cylinder 19 having a relatively thin thickness. In order to understand this point, an injection device 3X according to a comparative example will be described with reference to FIG. 5. The injection device 3X according to the comparative example is also provided with the injection nozzle 5 having the same configuration as the injection nozzle 5 (see FIG. 2) according to the present illustrative embodiment. However, an injection nozzle attachment member for attaching the injection nozzle 5 is different from that of the present illustrative embodiment.

Specifically, in the injection device 3X according to the comparative example, the injection nozzle attachment member is a cylinder head 50. The cylinder head 50 is fixed to a heating cylinder 19X by bolts 51 and 51. In this case, it is necessary to form tapped holes 53 and 53 for screwing the bolts 51 and 51 on an end surface of a tip end of the heating cylinder 19X. If the thickness of the heating cylinder 19X is not sufficient, it is difficult to form the tapped holes 53 and 53. In contrast to such a comparative example, since the injection nozzle attachment member 30 (see FIG. 2) according to the present illustrative embodiment can attach the injection nozzle 5 without forming a tapped hole on the heating cylinder 19, there is no need to take into consideration the thickness of the heating cylinder 19.

### Modifications

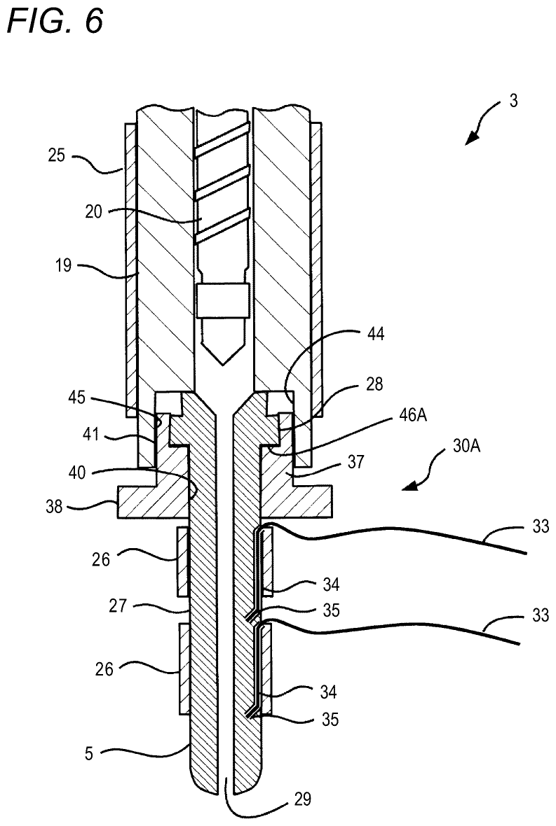

The injection nozzle attachment member 30 according to the present illustrative embodiment may be variously deformed. FIG. 6 shows a state in which the injection nozzle 5 is attached to the heating cylinder 19 by an injection nozzle attachment member 30A according to a modification. In the injection nozzle attachment member 30A according to the modification of the present illustrative embodiment, the male thread 41 is also formed on the cylindrical portion 37, and is screwed into the female thread 45 of the hole 44 in the axial direction of the heating cylinder 19.

However, in the injection nozzle attachment member 30A according to the modification, a flange pressing portion 46A that presses the flange portion 28 of the injection nozzle 5 is different from that of the present illustrative embodiment (see FIGS. 2 and 3). That is, in the injection nozzle attachment member 30A according to the modification, the through hole 40 is enlarged in a stepped shape in the vicinity of the rear end portion, and a stepped portion is formed. This stepped portion serves as the flange pressing portion 46A for pressing the flange portion 28. In the injection nozzle attachment member 30A according to this modification, the injection nozzle 5 can be reliably attached even when the hole 44 formed on the heating cylinder 19 is relatively shallow and the length of the female thread 45 is relatively short.

Although the invention made by the present inventor has been specifically described above based on the illustrative embodiments, it is needless to say that the present invention is not limited to the illustrative embodiments described above, and various modifications can be made without departing from the scope of the invention. The plurality of examples described above may be appropriately combined.

What is claimed is:

1. An injection nozzle attachment member for attaching an injection nozzle to a tip end of a heating cylinder, the injection nozzle including a cylindrical body portion and a flange portion with an enlarged diameter at a rear end, the injection nozzle attachment member comprising:
a male thread formed on an outer peripheral surface of a rear end portion; and
a flange pressing portion provided at a predetermined portion and configured to press the flange portion against the heating cylinder,
wherein the injection nozzle attachment member has a through hole at an axial center for receiving the body portion of the injection nozzle, and
wherein the injection nozzle attachment member is configured such that in a case where the through hole receives the body portion of the injection nozzle inserted and the male thread is screwed into a female thread formed at a tip end of the heating cylinder for attachment to the heating cylinder, the flange pressing portion presses the flange portion for the attachment of the injection nozzle.

2. The injection nozzle attachment member according to claim 1, wherein the injection nozzle attachment member includes a fastening portion to be engaged with a fastening tool for rotation.

3. The injection nozzle attachment member according to claim 1, wherein the flange pressing portion is an end surface of the rear end portion.

4. The injection nozzle attachment member according to claim 1, wherein the through hole is enlarged in a stepped shape near an outlet, and the enlarged stepped portion serves as the flange pressing portion.

5. An injection device comprising:
a heating cylinder;
a screw placed in the heating cylinder;
an injection nozzle attached to a tip end of the heating cylinder; and
an injection nozzle attachment member attaching the injection nozzle to the heating cylinder,
wherein the heating cylinder has a hole in an axial direction at a tip end, and a female thread is formed on the hole,
wherein the injection nozzle includes:
a cylindrical body portion; and
a flange portion with an enlarged diameter at a rear end,
wherein the injection nozzle attachment member has a through hole at an axial center for receiving the body portion of the injection nozzle inserted,
wherein the injection nozzle attachment member includes:
a male thread formed on an outer peripheral surface of a rear end portion; and
a flange pressing portion provided at a predetermined portion and configured to press the flange portion against the heating cylinder, and
wherein the injection nozzle is attached to the heating cylinder by the injection nozzle attachment member such that the body portion is inserted into the through hole, the flange portion is pressed by the flange pressing portion, and the male thread is fastened to the female thread.

6. The injection device according to claim 5, wherein the injection nozzle attachment member includes a fastening portion to be engaged with a fastening tool for rotation.

7. The injection device according to claim 5, wherein the flange pressing portion is an end surface of the rear end portion of the injection nozzle attachment member.

8. The injection device according to claim 5, wherein the through hole of the injection nozzle attachment member is enlarged in a stepped shape near an outlet, and the enlarged stepped portion serves as the flange pressing portion.

9. An injection molding machine comprising:
a mold clamping device configured to clamp a mold; and
an injection device configured to inject an injection material,
wherein the injection device includes:
a heating cylinder;
a screw placed in the heating cylinder;
an injection nozzle attached to a tip end of the heating cylinder; and
an injection nozzle attachment member attaching the injection nozzle to the heating cylinder,
wherein the heating cylinder has a hole in an axial direction at a tip end, and a female thread is formed on the hole,
wherein the injection nozzle includes:
a cylindrical body portion; and
a flange portion with an enlarged diameter at a rear end,
wherein the injection nozzle attachment member has a through hole at an axial center into which the body portion is inserted,
wherein the injection nozzle attachment member includes:
a male thread formed on an outer peripheral surface of a rear end portion; and
a flange pressing portion provided at a predetermined portion and configured to press the flange portion against the heating cylinder, and
wherein the injection nozzle is attached to the heating cylinder by the injection nozzle attachment member such that the body portion is inserted into the through hole, the flange portion is pressed by the flange pressing portion, and the male thread is fastened to the female thread.

10. The injection molding machine according to claim 9, wherein the injection nozzle attachment member includes a fastening portion to be engaged with a fastening tool for rotation.

11. The injection molding machine according to claim 9, wherein the flange pressing portion is an end surface of the rear end portion of the injection nozzle attachment member.

12. The injection molding machine according to claim 9, wherein the through hole of the injection nozzle attachment member is enlarged in a stepped shape near an outlet, and the enlarged stepped portion serves as the flange pressing portion.
